(19) United States
(12) Patent Application Publication
(10) Pub. No.: US 2010/0164393 A1
(43) Pub. Date: Jul. 1, 2010

(54) LIGHT SOURCE DRIVING CIRCUIT

(75) Inventors: Shih-Hsien Chang, Taoyuan Hsien (TW); Ming-Chih Hsieh, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/485,496

(22) Filed: Jun. 16, 2009

(30) Foreign Application Priority Data
Dec. 31, 2008 (TW) 097151596

(51) Int. Cl. H05B 41/16

(52) U.S. Cl. 315/279

(57) ABSTRACT

A light source driving circuit includes a transformer, a switching circuit, a control circuit, a brightness adjusting circuit and an isolator circuit. The brightness adjusting circuit is connected to a secondary winding assembly of the transformer and the light-emitting element for detecting an output voltage and/or an output current and generating a control signal according to the brightness adjusting signal. The isolator circuit is used for isolating the primary winding assembly of the transformer from the brightness adjusting circuit. The isolator circuit generates a feedback current according to the control signal. According to the feedback current, the switching circuit is controlled by the control circuit. As a status of the brightness adjusting signal is changed, a status of the control signal is changed and a time period of changing the status of the control signal is longer than a time period of changing the status of the brightness adjusting signal.

### FIELD OF THE INVENTION

The present invention relates to a light source driving circuit, and more particularly to a light source driving circuit for enhancing safety and reducing light source scintillation when the light-emitting element is driven by the light source driving circuit.

### BACKGROUND OF THE INVENTION

In recent years, cold cathode fluorescent lamps (CCFLs) and light emitting diodes (LEDs) have been widely used. In comparison with the common incandescent lamps, LEDs or CCFLs have an increased illuminating efficiency and an extended service life. With the maturity of the LED and CCFL technology, LEDs or CCFLs will replace all conventional lighting facilities. Until now, LEDs or CCFLs are widely used in many aspects of daily lives, such as household lighting device, automobile lighting devices, handheld lighting devices, backlight sources for LCD panels, traffic lights, indicator board displays, and the like.

Generally, the cold cathode fluorescent lamp or the light emitting diode is driven to illuminate by a light source driving circuit. In addition, the brightness value of the cold cathode fluorescent lamp or the light emitting diode is controlled by the light source driving circuit. Based on the persistence of vision, the cold cathode fluorescent lamp or the light emitting diode is alternately turned on and turned off so as to intermittently emit light under the circumstance imperceptible to the human beings.

The conventional light source driving circuit includes a control circuit, a transformer and a switching circuit. The control circuit generates a control signal. According to the control signal, the switching circuit is alternately conducted or shut off. As such, the utility power received by the primary winding assembly of the transformer is converted into a regulated voltage, which is transmitted from the secondary winding assembly of the transformer to the cold cathode fluorescent lamp or the light emitting diode. Moreover, according to a brightness adjusting signal, the control circuit will control the duty cycle or the switching frequency of the switching circuit. Generally, the brightness adjusting signal includes alternate enabling signal and disabling signal. In response to the enabling signal, the cold cathode fluorescent lamp or the light emitting diode illuminates. In response to the disabling signal, the cold cathode fluorescent lamp or the light emitting diode is turned off. As the duty cycle or the switching frequency of the switching circuit is changed, the regulated voltage transmitted from the secondary winding assembly of the transformer is altered. As the regulated voltage transmitted from the secondary winding assembly of the transformer is altered, the time period of turning on or turning off the cold cathode fluorescent lamp or the light emitting diode will be increased or decreased. According to the brightness adjusting signal, the brightness value of the cold cathode fluorescent lamp or the light emitting diode is adjustable.

Since the control circuit of the conventional light source driving circuit is connected to the utility power through the primary winding assembly of the transformer and the brightness adjusting signal is directly transmitted to the control circuit, the user has a risk of getting an electric shock during the process of operating the brightness adjusting signal. In other words, the electrical safety of the conventional light source driving circuit is unsatisfactory.

Moreover, since the time period of switching the brightness adjusting signal from the enabling signal to the disabling signal or the time period of switching the brightness adjusting signal from the disabling signal to the enabling signal is very short, a problem of causing light source scintillation will occur when the cold cathode fluorescent lamp or the light emitting diode is driven by the conventional light source driving circuit.

There is a need of providing a light source driving circuit to obviate the drawbacks encountered from the prior art.

### SUMMARY OF THE INVENTION

It is an object of the present invention to provide a light source driving circuit having enhanced electrical safety and reduced light source scintillation when the light-emitting element is driven by the light source driving circuit.

In accordance with an aspect of the present invention, there is provided a light source driving circuit for driving at least one light-emitting element and controlling a brightness value of the light-emitting element according to a brightness adjusting signal. The light source driving circuit includes a transformer, a switching circuit, a control circuit, a brightness adjusting circuit and an isolator circuit. The transformer includes a primary winding assembly and a secondary winding assembly. The secondary winding assembly is electrically connected to the light-emitting element. The switching circuit is electrically connected to the primary winding assembly of the transformer. A control circuit is electrically connected to the switching circuit. The brightness adjusting circuit is electrically connected to the secondary winding assembly of the transformer and the light-emitting element for detecting an output voltage and/or an output current outputted from the secondary winding assembly and generating a control signal according to the brightness adjusting signal. The isolator circuit is electrically connected to the brightness adjusting circuit and the control circuit for isolating the primary winding assembly of the transformer from the brightness adjusting circuit. The isolator circuit generates a feedback current according to the control signal. The switching circuit is controlled by the control circuit according to the feedback current. As a status of the brightness adjusting signal is changed, a status of the control signal is changed and a time period of changing the status of the control signal is longer than a time period of changing the status of the brightness adjusting signal.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram of a light source driving circuit according to a first embodiment of the present invention;

FIG. 2 is a schematic circuit diagram illustrating a variant of the light source driving circuit according to the first embodiment of the present invention;

FIG. 3 is a timing waveform diagram schematically illustrating the corresponding voltage signals processed in the light source driving circuit of FIG. 1;

FIG. 4 is a schematic circuit diagram of a light source driving circuit according to a second embodiment of the present invention;

FIG. 5 is a schematic detailed circuit diagram of the compensating circuit of FIG. 4;

FIG. 6 is a timing waveform diagram schematically illustrating the corresponding voltage signals processed in the light source driving circuit of FIG. 4; and

FIG. 7 is a schematic circuit diagram of a light source driving circuit according to a third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

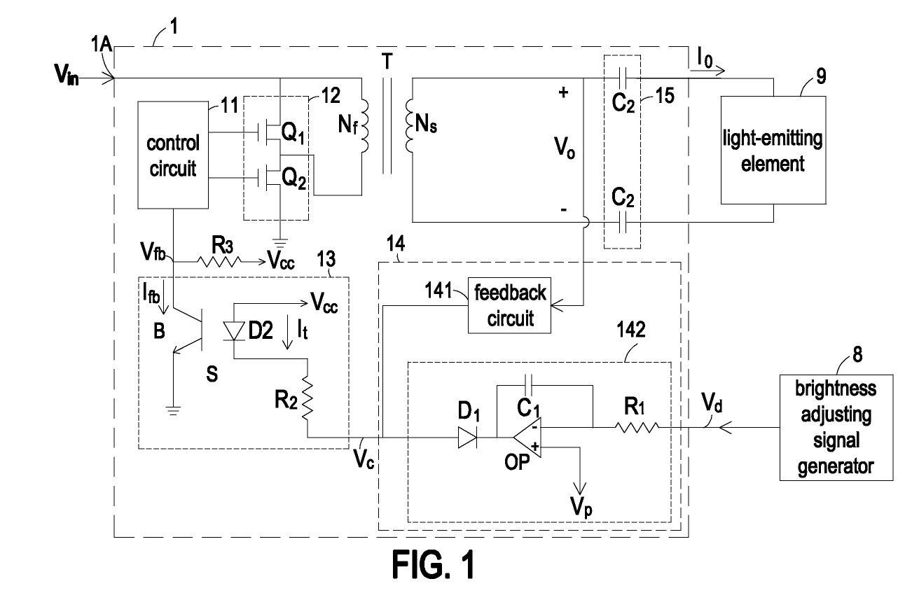

FIG. 1 is a schematic circuit diagram of a light source driving circuit according to a first embodiment of the present invention. As shown in FIG. 1, the light source driving circuit 1 is electrically connected to at least a light-emitting element 9. An example of the light-emitting element 9 includes a cold cathode fluorescent lamp (CCFL) or a light emitting diode (LED). An input voltage Vᵢₙ (e.g. utility power) is converted by the light source driving circuit 1 into an output voltage Vₒ required for illuminating the light-emitting element 9. Furthermore, the light source driving circuit 1 is electrically connected to a brightness adjusting signal generator 8. The brightness adjusting signal generator 8 is used for generating a brightness adjusting signal V_{d}. According to the brightness adjusting signal V_{d}, the light source driving circuit 1 can adjust the brightness value of the light emitted by the light-emitting element 9. The brightness adjusting signal V_{d} includes alternate enabling signal and disabling signal. In response to the enabling signal, the light-emitting element 9 illuminates. In response to the disabling signal, the light-emitting element 9 is turned off. As shown in FIG. 1, the light source driving circuit 1 principally comprises a control circuit 11, a switching circuit 12, an isolator circuit 13, a brightness adjusting circuit 14 and a transformer T. The primary winding assembly N_{f} of the transformer T is connected to the input terminal 1A of the light source driving circuit 1. The input voltage Vᵢₙ is received by the primary winding assembly N_{f} and then magnetically transmitted to the secondary winding assembly Nₛ of the transformer T. As such, the secondary winding assembly Nₛ generates the output voltage Vₒ.

The switching circuit 12 is connected to the control circuit 11, the primary winding assembly N_{f}, a common terminal and the input terminal 1A of the light source driving circuit 1. Under control of the control circuit 11, the switching circuit 12 is alternately conducted or shut off. The electric energy received by the primary winding assembly N_{f} will be magnetically transmitted to the secondary winding assembly Nₛ of the transformer T, and thus the secondary winding assembly Nₛ generates the output voltage Vₒ.

In this embodiment, the switching circuit 12 includes a first switch Q₁ and a second switch Q₂. The first switch Q₁ is connected to the primary winding assembly N_{f} of the transformer T, the second switch Q₂, the input terminal 1A of the light source driving circuit 1 and the control circuit 11. The second switch Q₂ is interconnected between the first switch Q₁ and the common terminal in series. The second switch Q₂ is also connected to the primary winding assembly N_{f} of the transformer T and the control circuit 11. Under control of the control circuit 11, the first switch Q₁ and the second switch Q₂ are alternately conducted or shut off.

A first input terminal of the brightness adjusting circuit 14 is connected to the secondary winding assembly Nₛ of the transformer T and the light-emitting element 9. A second input terminal of the brightness adjusting circuit 14 is connected to the brightness adjusting signal generator 8. An output terminal of the brightness adjusting circuit 14 is connected to the input terminal of the isolator circuit 13. The brightness adjusting circuit 14 is used for detecting the output voltage Vₒ that is outputted from the secondary winding assembly Nₛ of the transformer T. In addition, according to the brightness adjusting signal V_{d}, the brightness adjusting circuit 14 generates a control signal V_{c}. As the status of the brightness adjusting signal V_{d} is switched from the enabling signal to the disabling signal or from the disabling signal to the enabling signal, the status of the control signal V_{c} is altered. Under control of the brightness adjusting circuit 14, the time period of changing the status of the control signal V_{c} is adjusted, and the time period of changing the status of the control signal V_{c} is longer than the time period of changing the status of the brightness adjusting signal V_{d}.

In this embodiment, the brightness adjusting circuit 14 includes a feedback circuit 141 and a brightness adjusting signal converting circuit 142. The input terminal of the feedback circuit 141 is connected to the secondary winding assembly Nₛ of the transformer T and the light-emitting element 9. The output terminal of the feedback circuit 141 is connected to the output terminal of the brightness adjusting circuit 14. The feedback circuit 141 is used for detecting the output voltage Vₒ that is outputted from the secondary winding assembly Nₛ of the transformer T. The input terminal of the brightness adjusting signal converting circuit 142 is connected to the brightness adjusting signal generator 8. The output terminal of the brightness adjusting signal converting circuit 142 is connected to the output terminal of the feedback circuit 141 and the output terminal of the brightness adjusting circuit 14. The brightness adjusting signal converting circuit 142 is used for receiving the brightness adjusting signal V_{d} and increasing the time period of changing the status of the brightness adjusting signal V_{d}. According to the output voltage Vₒ received by the feedback circuit 141 and the brightness adjusting signal V_{d} received by the brightness adjusting signal converting circuit 142, the brightness adjusting circuit 14 generates the control signal V_{c}. By the brightness adjusting signal converting circuit 142, the time period of changing the status of the control signal V_{c} is adjusted, and the time period of changing the status of the control signal V_{c} is longer than the time period of changing the status of the brightness adjusting signal V_{d}.

The brightness adjusting signal converting circuit 142 comprises a signal amplifier OP, a first capacitor C₁, a first resistor R₁ and a first diode D₁. An end of the first resistor R₁ is connected to the brightness adjusting signal generator 8. The other end of the first resistor R₁ is connected to the negative terminal of the signal amplifier OP. The positive terminal of the signal amplifier OP receives a reference voltage Vₚ. The brightness adjusting signal V_{d} is transmitted from the brightness adjusting signal generator 8 to the negative terminal of the signal amplifier OP through the first resistor R₁. The output terminal of the signal amplifier OP is connected to the cathode of the first diode D₁. The anode of the first diode D₁ is connected to the output terminal of the feedback circuit 141. An end of the first capacitor C₁ is connected to the first resistor R₁ and the negative terminal of the signal amplifier OP. The other end of the first capacitor C₁ is connected to the output terminal of the signal amplifier OP and the cathode of the first diode D₁.

The input terminal of the isolator circuit 13 is connected to the output terminal of the brightness adjusting circuit 14. The output terminal of the isolator circuit 13 is connected to the control circuit 11. The isolator circuit 13 is used for isolating the primary winding assembly N_{f} of the transformer T from the brightness adjusting circuit 14. As a consequence, the safety of the light source driving circuit 1 is increased. By means of the isolator circuit 13, the user will not be directly contacted with the input voltage Vᵢₙ during the brightness adjusting signal V_{d} is generated by the brightness adjusting signal generator 8.

In this embodiment, the isolator circuit 13 includes a photo coupler S and a second resistor R₂. The input terminal of the photo coupler S is connected to a light-emitting diode D₂. The light-emitting diode D₂ receives a source voltage V_{cc} and is connected to an end of the second resistor R₂. The other end of the second resistor R₂ is connected to the output terminal of the brightness adjusting circuit 14 for receiving the control signal V_{c} that is transmitted from the brightness adjusting circuit 14. According to the voltage difference between the source voltage V_{cc} and the control signal V_{c}, the input terminal of the isolator circuit 13 generates a detecting current Iₜ. The current value of the detecting current Iₜ is dependent on the voltage value change of the control signal V_{c}. The output terminal of the photo coupler S is connected to a photo transistor B. In other words, the photo transistor B is connected between the control circuit 11 and the common terminal in series. According to the detecting current Iₜ, the output terminal of the isolator circuit 13 generates a feedback current I_{fb}.

In this embodiment, the light source driving circuit 1 further includes a third resistor R₃. An end of the third resistor R₃ receives the source voltage V_{cc}. The other end of the third resistor R₃ is connected between the control circuit 11 and the isolator circuit 13. When the output terminal of the isolator circuit 13 generates the feedback current I_{fb}, a feedback voltage V_{fb} is generated by the third resistor R₃.

The input terminal of the control circuit 11 is connected to the output terminal of the isolator circuit 13. The output terminal of the control circuit 11 is connected to the switching circuit 12. The control circuit 11 can generate for example a pulse width modulation signal. The switching circuit 12 is alternately conducted or shut off in response to the pulse width modulation signal. According to the feedback current I_{fb} transmitted from the output terminal of the isolator circuit 13 and/or the feedback voltage V_{fb} generated by the third resistor R₃, the duty cycle or the switching frequency of the switching circuit 12 is adjustable. In other words, as the feedback current I_{fb} and/or the feedback voltage V_{fb} is changed, the output voltage Vₒ that is outputted from the secondary winding assembly Nₛ of the transformer T is altered. According to the brightness adjusting signal V_{d}, the light source driving circuit 1 can control the brightness value of the light emitted by the light-emitting element 9.

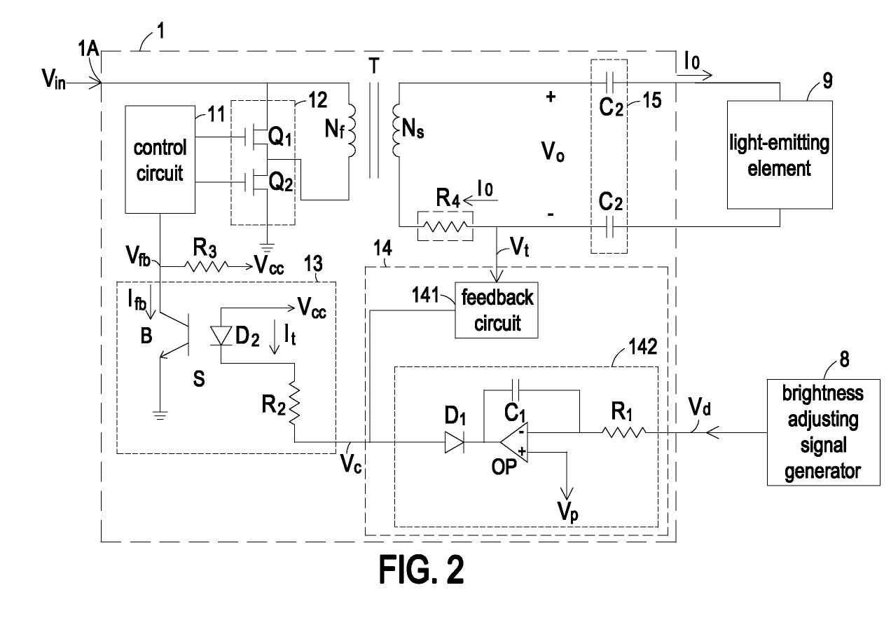

In the above embodiment, the feedback circuit 141 can directly detect the output voltage Vₒ that is outputted from the secondary winding assembly Nₛ of the transformer T. FIG. 2 is a schematic circuit diagram illustrating a variant of the light source driving circuit according to the first embodiment of the present invention. In comparison with FIG. 1, the light source driving circuit 1 of FIG. 2 further includes a fourth resistor R₄. The fourth resistor R₄ is interconnected between the secondary winding assembly Nₛ of the transformer T and the light-emitting element 9. In addition, the brightness adjusting circuit 14 is connected to the fourth resistor R₄ and the light-emitting element 9. When an output current Iₒ generated by the secondary winding assembly Nₛ of the transformer T flows through the fourth resistor R₄, the fourth resistor R₄ generates a corresponding detecting voltage Vₜ. According to the detecting voltage Vₜ, the brightness adjusting circuit 14 can indirectly detect the output voltage Vₒ.

Please refer to FIGS. 1 and 2. In these embodiments, the light source driving circuit 1 further includes a sharing circuit 15. The sharing circuit 15 is interconnected between the secondary winding assembly Nₛ of the transformer T and every light-emitting element 9. In a case that the at least one light-emitting element 9 includes multiple light-emitting elements 9, the currents flowing into all of the multiple light-emitting elements 9 are equal by means of the sharing circuit 15. In some embodiments, the sharing circuit 15 includes at least a second capacitor C₂.

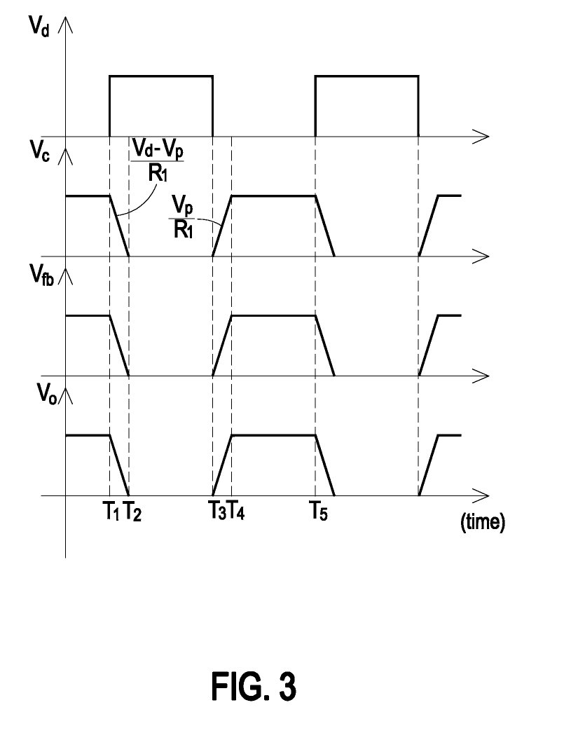

FIG. 3 is a timing waveform diagram schematically illustrating the corresponding voltage signals processed in the light source driving circuit of FIG. 1. Hereinafter, the principle of controlling the switching circuit 12 according to the feedback voltage V_{fb} that is transmitted from the third resistor R₃ will be illustrated with FIGS. 1, 2 and 3. In accordance with a key feature of the present invention, whether the brightness adjusting signal V_{d} is an enabling signal or a disabling signal is dependent on the illuminating status of the light-emitting element 9. In a case that the brightness adjusting signal V_{d} is at a low-level status from t=T₃ to T₅ for example, a high-level output voltage Vₒ is outputted from the light source driving circuit 1 to drive illumination of the light-emitting element 9. That is, the brightness adjusting signal V_{d} at the low-level status indicates the enabling signal. Whereas, in a case that the brightness adjusting signal V_{d} is at a high-level status from t=T₁ to T₃ for example, a low-level output voltage Vₒ is outputted from the light source driving circuit 1 to turn off the light-emitting element 9. That is, the brightness adjusting signal V_{d} at the high-level status indicates the disabling signal.

At t=T₁, the brightness adjusting signal V_{d} is switched from a low-level status (i.e. an enabling signal) to a high-level status (i.e. a disabling signal). As shown in FIG. 3, the time period of changing the status of the brightness adjusting signal V_{d} is very short. As the status of the brightness adjusting signal V_{d} is changed, the control signal V_{c} outputted from the brightness adjusting circuit 14 is altered. As shown in FIG. 3, the control signal V_{c} is switched from the high-level status (at t=T₁) to the low-level status (at t=T₂). That is, from t=T₁ to T₂, the control signal V_{c} is decreased at a rate of (V_{d}−Vₚ)/R₁, where V_{d}, Vₚ and R₁ indicate the voltage value of the brightness adjusting signal V_{d}, the voltage value of the reference voltage Vₚ and the resistance value of the first resistor R₁, respectively. Like the control signal V_{c}, the feedback voltage V_{fb} and the output voltage Vₒ are also decreased at a specified rate from t=T₁ to T₂. When the output voltage Vₒ is at the low-level status, the light-emitting element 9 is turned off.

At t=T₃, the brightness adjusting signal V_{d} is switched from a high-level status (i.e. a disabling signal) to a low-level status (i.e. an enabling signal). As shown in FIG. 3, the time period of changing the status of the brightness adjusting signal V_{d} is also very short. As the status of the brightness adjusting signal V_{d} is changed, the control signal V_{c} outputted from the brightness adjusting circuit 14 is altered. As shown in FIG. 3, the control signal V_{c} is switched from the low-level status (at t=T₃) to the high-level status (at t=T₄). That is, from t=T₃ to T₄, the control signal V_{c} is increased at a rate of Vₚ/R₁, where Vₚ and R₁ indicate the voltage value of the reference voltage Vₚ and the resistance value of the first resistor R₁, respectively. Like the control signal V_{c}, the feedback voltage V_{fb} and the output voltage Vₒ are also increased at a specified rate from t=T₃ to T₄. When the output voltage Vₒ is at the high-level status, the light-emitting element 9 illuminates.

Please refer to FIG. 3 again. The time period of switching the control signal V_{c} from the high-level status to the low-level status is longer than the time period of switching the brightness adjusting signal V_{d} from the enabling signal to the disabling signal. Similarly, the time period of switching the control signal V_{c} from the low-level status to the high-level status is longer than the time period of switching the brightness adjusting signal V_{d} from the disabling signal to the enabling signal. Similarly, the time period of switching the feedback voltage V_{fb} or the output voltage Vₒ from the low-level status to the high-level status or from the high-level status to the low-level status is longer than the time period of changing the status of the brightness adjusting signal V_{d}. When the light-emitting element 9 is driven to illuminate by the output voltage Vₒ that is generated by the light source driving circuit 1, the light source scintillation is reduced because the time period of changing the status of the output voltage Vₒ is increased.

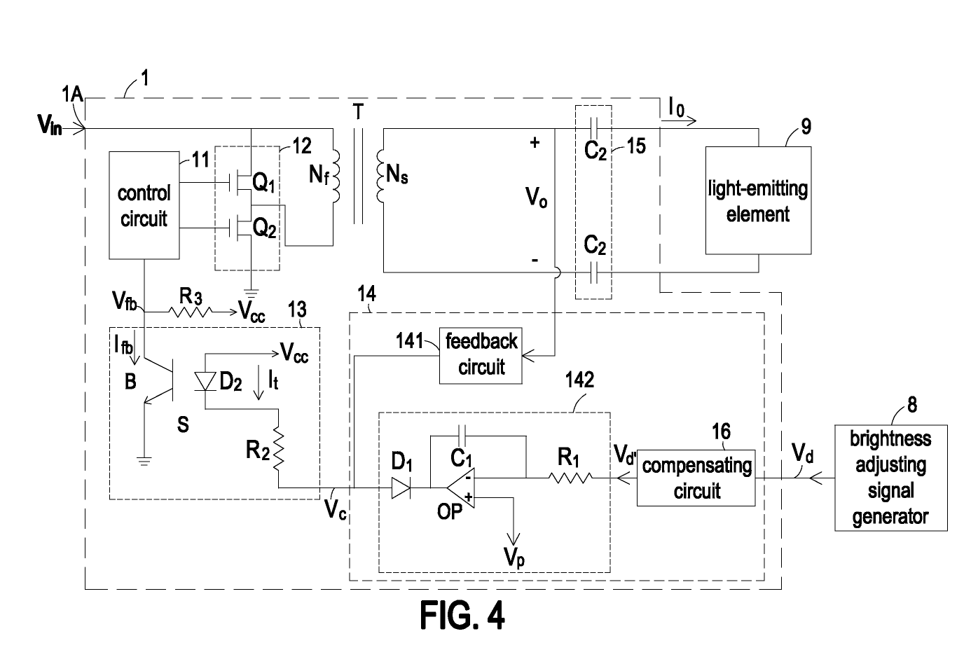

When the brightness value of the light-emitting element 9 is adjusted by the light source driving circuit 1 according to the brightness adjusting signal V_{d}, the control circuit 11 of the light source driving circuit 1 is possibly affected by the external environment or the internal components and thus the control circuit 11 fails to precisely control operations of the switching circuit 12. Under this circumstance, the duration of illuminating the light-emitting element 9 is shorter than the duration of the enabling signal of the brightness adjusting signal V_{d} and the light source driving circuit 1 fails to precisely control the brightness value of the light-emitting element 9. For compensating the adverse effect of the external environment or the internal components, the brightness adjusting circuit 14 of the light source driving circuit 1 further comprises a compensating circuit 16 (see FIG. 4).

FIG. 4 is a schematic circuit diagram of a light source driving circuit according to a second embodiment of the present invention. As shown in FIG. 4, the brightness adjusting circuit 14 of the light source driving circuit 1 further comprises a compensating circuit 16. The input terminal of the compensating circuit 16 is connected to the brightness adjusting signal generator 8. The output terminal of the compensating circuit 16 is connected to the brightness adjusting signal converting circuit 142. The compensating circuit 16 is used for increasing the duration of the enabling signal of the brightness adjusting signal V_{d}, thereby generating a compensated brightness adjusting signal V_{d′} to the brightness adjusting circuit 14. Under this circumstance, the brightness adjusting circuit 14 generates a control signal V_{c} according to the compensated brightness adjusting signal V_{d′} and the output voltage Vₒ. Even if the control circuit 11 fails to precisely control operations of the switching circuit 12 due to the adverse influence of the external environment or the internal components, the duration of the enabling signal of the brightness adjusting signal V_{d} is increased. According to the compensated brightness adjusting signal V_{d′}, the brightness value of the light-emitting element 9 can be precisely adjusted by the light source driving circuit 1. As the status of the compensated brightness adjusting signal V_{d′} is changed, the time period of changing the status of the control signal V_{c} is longer than the time period of changing the status of the compensated brightness adjusting signal V_{d′} by the brightness adjusting signal converting circuit 142. As a consequence, the light source scintillation is reduced when the light-emitting element 9 is driven to illuminate by the light source driving circuit 1.

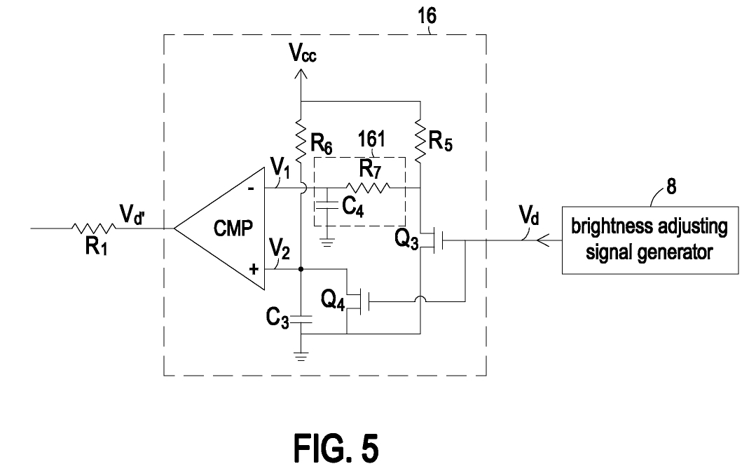

FIG. 5 is a schematic detailed circuit diagram of the compensating circuit of FIG. 4. The compensating circuit 16 includes a third switch Q₃, a fourth switch Q₄, a fifth resistor R₅, a sixth resistor R₆, a third capacitor C₃, a filtering circuit 161 and a comparator CMP. The third switch Q₃ is connected to the brightness adjusting signal generator 8, the fifth resistor R₅, the filtering circuit 161 and the common terminal. The fourth switch Q₄ is connected to the brightness adjusting signal generator 8, the third capacitor C₃, the positive terminal of the comparator CMP, the sixth resistor R₆ and the common terminal. According to the brightness adjusting signal V_{d} transmitted from the brightness adjusting signal generator 8, the third switch Q₃ and the fourth switch Q₄ are simultaneously conducted or shut off.

The fifth resistor R₅ is connected to the third switch Q₃, the sixth resistor R₆ and the filtering circuit 161. The sixth resistor R₆ is connected to the third capacitor C₃, the fourth switch Q₄, the fifth resistor R₅ and the positive terminal of the comparator CMP. Both of the fifth resistor R₅ and the sixth resistor R₆ receive a source voltage V_{cc}.

The filtering circuit 161 is connected to the fifth resistor R₅, the third switch Q₃, the negative terminal of the comparator CMP and the common terminal. The source voltage V_{cc} is transmitted to the filtering circuit 161 through the fifth resistor R₅. The source voltage V_{cc} is filtered by the filtering circuit 161 and then transmitted to the negative terminal of the comparator CMP. In this embodiment, the filtering circuit 161 further includes a seventh resistor R₇ and a fourth capacitor C₄. The seventh resistor R₇ is connected to the fifth resistor R₅, the third switch Q₃, the negative terminal of the comparator CMP and the fourth capacitor C₄. The fourth capacitor C₄ is connected to the seventh resistor R₇, the negative terminal of the comparator CMP and the common terminal.

The third capacitor C₃ is connected to the positive terminal of the comparator CMP, the sixth resistor R₆, the fourth switch Q₄ and the common terminal. The output terminal of the comparator CMP is connected to the output terminal of the compensating circuit 16 and the first resistor R₁ of the brightness adjusting signal converting circuit 142. The negative terminal of the comparator CMP is connected to the filtering circuit 161. The positive terminal of the comparator CMP is connected to the sixth resistor R₆, the fourth switch Q₄ and the third capacitor C₃.

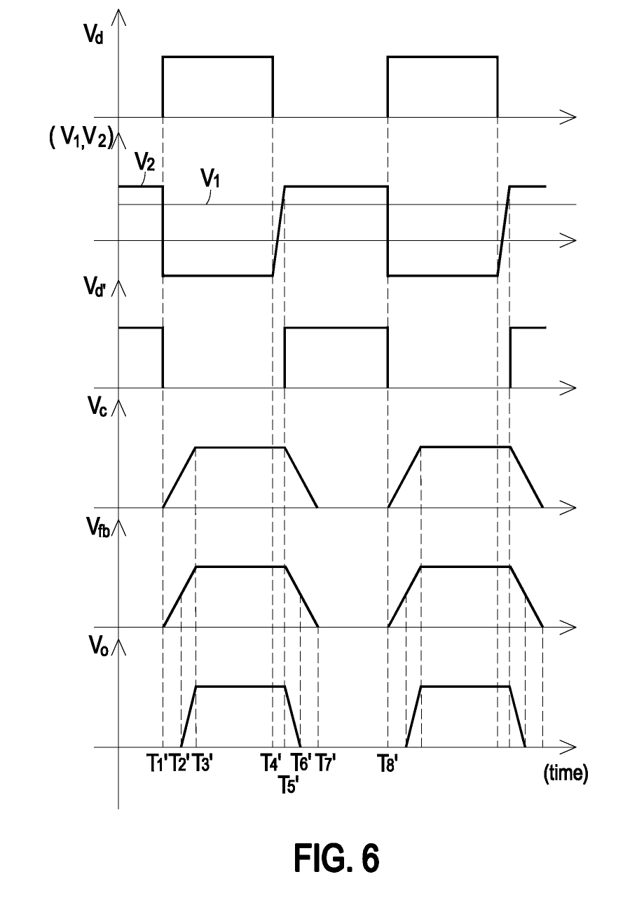

FIG. 6 is a timing waveform diagram schematically illustrating the corresponding voltage signals processed in the light source driving circuit of FIG. 4. Hereinafter, the operations of the light source driving circuit 1 having the compensating circuit 16 will be illustrated with reference to FIGS. 4, 5 and 6. It is assumed that the control circuit 11 of the light source driving circuit 1 is affected by the external environment or the internal components and fails to precisely control operations of the switching circuit 12. As shown in FIG. 5, a first voltage V₁ and a second voltage V₂ are respectively inputted into the negative terminal and the positive terminal of the comparator CMP. As shown in FIG. 6, the brightness adjusting signal V_{d} is at a high-level status from t=T_{1′} to T_{4′} for example, the third switch Q₃ and the fourth switch Q₄ are simultaneously conducted. Meanwhile, the source voltage V_{cc} is transmitted to the filtering circuit 161 through the fifth resistor R₅. The source voltage V_{cc} is filtered by the filtering circuit 161 and then transmitted to the negative terminal of the comparator CMP. As such, the first voltage V₁ received by the negative terminal of the comparator CMP is maintained at a constant level. At the same time, the source voltage V_{cc} is transmitted to the third capacitor C₃ through the sixth resistor R₆ so as to charge the third capacitor C₃. Since the fourth switch Q₄ is conducted, the second voltage V₂ received by the positive terminal of the comparator CMP is at a low-level status. Since the first voltage V₁ is greater than the second voltage V₂, the output terminal of the comparator CMP generates a low-level compensated brightness adjusting signal V_{d′}.

From t=T_{4′} to T_{8′} for example, the brightness adjusting signal V_{d} is at a low-level status the third switch Q₃ and the fourth switch Q₄ are simultaneously shut off. Meanwhile, the first voltage V₁ received by the negative terminal of the comparator CMP is also maintained at the constant level. As the third capacitor C₃ continuously discharges, the second voltage V₂ received by the positive terminal of the comparator CMP is gradually increased. Since the second voltage V₂ is still lower than the first voltage V₁ from t=T_{4′} to T_{5′}, the output terminal of the comparator CMP generates a low-level compensated brightness adjusting signal V_{d′}. After t=T_{5′}, the third capacitor C₃ continuously discharges and the second voltage V₂ is greater than the first voltage V₁, and thus the output terminal of the comparator CMP generates a high-level compensated brightness adjusting signal V_{d′}.

According to the compensated brightness adjusting signal V_{d′}, the brightness adjusting circuit 14 generates the control signal V_{c}. As the status of the compensated brightness adjusting signal V_{d′} is changed at t=T_{1′} and t=T_{5′}, the status of the control signal V_{c} is also changed at t=T_{1′} and t=T_{5′} under control of the brightness adjusting circuit 14. In addition, the time period of changing the status of the control signal V_{c} is longer than the time period of changing the status of the compensated brightness adjusting signal V_{d′} by the brightness adjusting signal converting circuit 142.

As the control signal V_{c} is changed, the feedback voltage V_{fb} and the output voltage Vₒ are also altered. If the control circuit 11 of the light source driving circuit 1 is affected by the external environment or the internal components and fails to precisely control operations of the switching circuit 12 according to the feedback voltage V_{fb}, the duration of maintaining the output voltage Vₒ at the high-level state (i.e. t=T_{2′} to T_{6′}) is shorter than the duration of maintaining the feedback voltage V_{fb} at the high-level state (i.e. t=T_{1′} to T_{7′}).

In a case that the brightness adjusting signal V_{d} is at a high-level status from t=T_{1′} to T_{4′} for example, a high-level output voltage Vₒ is outputted from the light source driving circuit 1 to drive illumination of the light-emitting element 9. That is, the brightness adjusting signal V_{d} at the high-level status indicates the enabling signal. Whereas, in a case that the brightness adjusting signal V_{d} is at a low-level status, a low-level output voltage Vₒ is outputted from the light source driving circuit 1 to turn off the light-emitting element 9. That is, the brightness adjusting signal V_{d} at the low-level status indicates the disabling signal. Since the control circuit 11 of the light source driving circuit 1 is affected by the external environment or the internal components, the output voltage Vₒ delays the brightness adjusting signal V_{d} by a delaying time of (T_{2′}−T_{1′}).

Please refer to FIG. 6 again. The compensating circuit 16 is used for increasing the duration of the enabling signal of the brightness adjusting signal V_{d}, thereby generating a compensated brightness adjusting signal V_{d′} to the brightness adjusting circuit 14. Although the durations of maintaining the control signal V_{c} and the feedback voltage V_{fb} at the high-level state are longer than the enabling duration of the brightness adjusting signal V_{d}, the durations of maintaining the output voltage Vₒ at the high-level state can be equal to the duration of the enabling signal of the brightness adjusting signal V_{d} by means of the compensating circuit 16. According to the compensated brightness adjusting signal V_{d′}, the brightness value of the light-emitting element 9 can be precisely adjusted by the light source driving circuit 1.

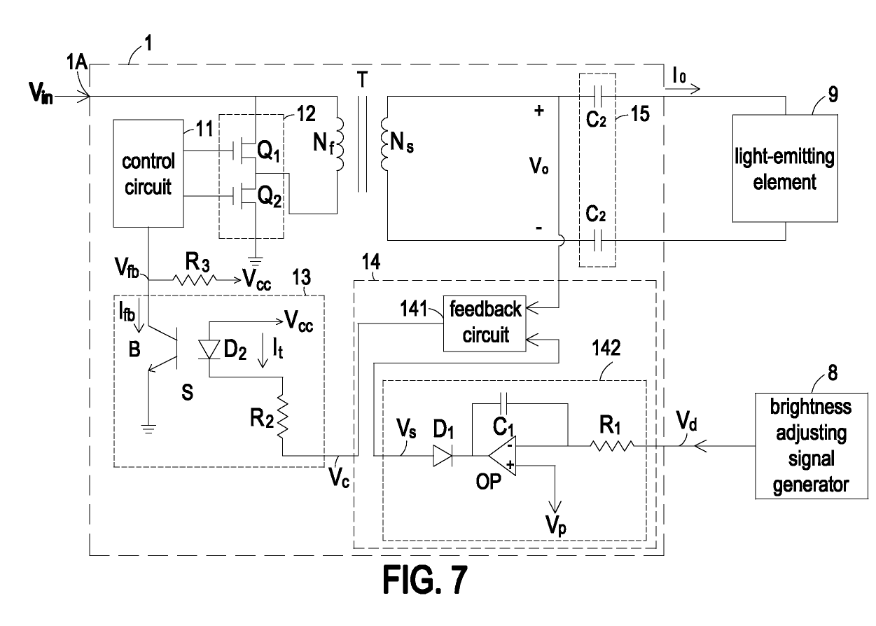

FIG. 7 is a schematic circuit diagram of a light source driving circuit according to a third embodiment of the present invention. Components corresponding to those of the first embodiment are designated by identical numeral references, and detailed description thereof is omitted. In comparison with FIG. 1, the output terminal of the brightness adjusting signal converting circuit 142 is connected to another input terminal of the feedback circuit 141. When the brightness adjusting signal V_{d} transmitted from the brightness adjusting signal generator 8 is received by the brightness adjusting signal converting circuit 142, the brightness adjusting signal converting circuit 142 will increase the time period of changing the brightness adjusting signal V_{d}, thereby generating a transit signal Vs to the feedback circuit 141. According to the output voltage Vₒ and the transit signal Vs, the feedback circuit 141 generates the control signal V_{c}. Similarly, the time period of changing the status of the control signal V_{c} is longer than the time period of changing the status of the brightness adjusting signal V_{d} by the brightness adjusting signal converting circuit 142. When the light-emitting element 9 is driven to illuminate by the output voltage Vₒ that is generated by the light source driving circuit 1, the light source scintillation is reduced because the time period of changing the status of the output voltage Vₒ is increased.

From the above description, the brightness adjusting circuit is isolated from the primary winding assembly of the transformer by an isolator circuit according to the present invention, and thus the light source driving circuit of the present invention has enhanced electrical safety. Moreover, since the time period of changing the status of the brightness adjusting signal is increased by the brightness adjusting circuit, the brightness value of the light-emitting element becomes more stable and the light source scintillation is reduced when the light-emitting element is driven to illuminate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light source driving circuit for driving at least one light-emitting element and controlling a brightness value of said light-emitting element according to a brightness adjusting signal, said light source driving circuit comprising:
a transformer comprising a primary winding assembly and a secondary winding assembly, wherein said secondary winding assembly is electrically connected to said light-emitting element;
a switching circuit electrically connected to said primary winding assembly of said transformer;
a control circuit electrically connected to said switching circuit;
a brightness adjusting circuit electrically connected to said secondary winding assembly of said transformer and said light-emitting element for detecting an output voltage and/or an output current outputted from said secondary winding assembly and generating a control signal according to the brightness adjusting signal; and
an isolator circuit electrically connected to said brightness adjusting circuit and said control circuit for isolating said primary winding assembly of said transformer from said brightness adjusting circuit, wherein said isolator circuit generates a feedback current according to said control signal and said switching circuit is controlled by said control circuit according to said feedback current,
wherein as a status of said brightness adjusting signal is changed, a status of said control signal is changed, and a time period of changing said status of said control signal is longer than a time period of changing said status of said brightness adjusting signal.

2. The light source driving circuit according to claim 1 wherein said light-emitting element includes a cold cathode fluorescent lamp or a light emitting diode.

3. The light source driving circuit according to claim 1 wherein said brightness adjusting signal is generated by a brightness adjusting signal generator.

4. The light source driving circuit according to claim 1 wherein said switching circuit includes a first switch and a second switch, which are connected to said control circuit and alternately conducted or shut off under control of said control circuit.

5. The light source driving circuit according to claim 1 wherein said brightness adjusting circuit comprises:
a feedback circuit electrically connected to said secondary winding assembly of said transformer and said light-emitting element for detecting said output voltage and/or said output current; and
a brightness adjusting signal converting circuit connected to said feedback circuit and an output terminal of said brightness adjusting circuit for receiving said brightness adjusting signal and increasing said time period of changing said status of said brightness adjusting signal, wherein said brightness adjusting circuit generates said control signal according to said output voltage and/or said output current received by said feedback circuit and said brightness adjusting signal received by said brightness adjusting signal converting circuit, so that said time period of changing said status of said control signal is adjusted to be longer than said time period of changing said status of said brightness adjusting signal by said brightness adjusting signal converting circuit.

6. The light source driving circuit according to claim 5 wherein said brightness adjusting signal converting circuit includes a signal amplifier, a first capacitor, a first resistor and a first diode, wherein said first resistor receives said brightness adjusting signal and is connected to a negative terminal of said signal amplifier, a positive terminal of said signal amplifier receives a reference voltage, an output terminal of said signal amplifier is connected to a cathode of said first diode, an anode of said first diode is connected to said output terminal of said brightness adjusting circuit, and said first capacitor is connected to said negative terminal and said output terminal of said signal amplifier.

7. The light source driving circuit according to claim 1 wherein said isolator circuit includes a photo coupler and a second resistor, said second resistor is connected to an input terminal of the photo coupler and said brightness adjusting circuit for receiving said control signal from said brightness adjusting circuit, said input terminal of said photo coupler receives a source voltage, and an output terminal of said photo coupler is connected to said control circuit.

8. The light source driving circuit according to claim 1 further comprising a third resistor, wherein said third resistor has an end receiving a source voltage and the other end connected to said control circuit and said isolator circuit, a feedback voltage is generated by said third resistor in response to said feedback current from said isolator circuit, and said control circuit controls operations of said switching circuit according to said feedback voltage.

9. The light source driving circuit according to claim 1 further comprising a fourth resistor, wherein said fourth resistor is connected to said secondary winding assembly of said transformer, said light-emitting element and said brightness adjusting circuit for issuing a detecting voltage to said brightness adjusting circuit according to said output voltage.

10. The light source driving circuit according to claim 1 further comprising a sharing circuit, wherein said sharing circuit is interconnected between said secondary winding assembly of the transformer and said at least one light-emitting element, wherein if said at least one light-emitting element includes multiple light-emitting elements, the currents flowing into all of said multiple light-emitting elements are equalized by said sharing circuit.

11. The light source driving circuit according to claim 1 wherein said brightness adjusting signal includes alternate enabling signal and disabling signal, said light-emitting element is driven to illuminate in response to the enabling signal, and said light-emitting element is turned off in response to the disabling signal.

12. The light source driving circuit according to claim 11 wherein said brightness adjusting circuit comprises:
a feedback circuit electrically connected to said secondary winding assembly of said transformer and said light-emitting element for detecting said output voltage and/or said output current;
a compensating circuit for receiving said brightness adjusting signal and increasing the duration of said enabling signal of said brightness adjusting signal, thereby generating a compensated brightness adjusting signal; and
a brightness adjusting signal converting circuit connected to said compensating circuit for receiving said compensated brightness adjusting signal and increasing a time period of changing a status of said compensated brightness adjusting signal, so that said time period of changing said status of said control signal is adjusted to be longer than said time period of changing said status of said compensated brightness adjusting signal and said time period of changing said status of said brightness adjusting signal.

13. The light source driving circuit according to claim 12 wherein said compensating circuit includes a third switch, a fourth switch, a fifth resistor, a sixth resistor, a third capacitor, a filtering circuit and a comparator, wherein said third switch is connected to said fifth resistor, said filtering circuit and a common terminal, said fourth switch is connected to said third capacitor, a positive terminal of said comparator, said sixth resistor and said common terminal, and said third switch and said fourth switch are simultaneously conducted or shut off according to said brightness adjusting signal.

14. The light source driving circuit according to claim 13 wherein said fifth resistor is connected to said third switch, said sixth resistor and said filtering circuit, said sixth resistor is connected to said third capacitor, said fourth switch, said fifth resistor and said positive terminal of said comparator, and both of said fifth resistor and said sixth resistor receive a source voltage.

15. The light source driving circuit according to claim 14 wherein said filtering circuit is connected to said fifth resistor, said third switch, a negative terminal of said comparator and said common terminal.

16. The light source driving circuit according to claim 15 wherein said filtering circuit further includes a seventh resistor and a fourth capacitor, said seventh resistor is connected to said fifth resistor, said third switch, said negative terminal of said comparator and said fourth capacitor, and said fourth capacitor is connected to said seventh resistor, said negative terminal of said comparator and said common terminal.

17. The light source driving circuit according to claim 15 wherein said third capacitor is connected to said positive terminal of said comparator, said sixth resistor, said fourth switch and said common terminal, said source voltage is transmitted to said third capacitor through said sixth resistor to charge said third capacitor when said fourth switch is conducted, and said third capacitor discharges when said fourth switch is shut off.

18. The light source driving circuit according to claim 17 wherein an output terminal of said comparator is connected to an output terminal of said compensating circuit, said negative terminal of said comparator is connected to said filtering circuit, said positive terminal of said comparator is connected to said sixth resistor, said fourth switch and said third capacitor, and said comparator generates said compensated brightness adjusting signal according to a first voltage and a second voltage that are respectively inputted into said negative terminal and said positive terminal of said comparator.

19. The light source driving circuit according to claim 1 wherein said brightness adjusting circuit comprises:
a feedback circuit electrically connected to said secondary winding assembly of said transformer and said light-emitting element for detecting said output voltage and/or said output current; and
a brightness adjusting signal converting circuit connected to said feedback circuit for receiving said brightness adjusting signal and increasing said time period of changing said status of said brightness adjusting signal, thereby generating a transit signal to said feedback circuit, wherein said brightness adjusting circuit generates said control signal according to said output voltage and/or said output current received by said feedback circuit and said transit signal, so that said time period of changing said status of said control signal is adjusted to be longer than said time period of changing said status of said brightness adjusting signal by said brightness adjusting signal converting circuit.
